(19) United States
(12) Patent Application Publication
(10) Pub. No.: US 2010/0000971 A1
(43) Pub. Date: Jan. 7, 2010

(54) ADHESIVE LAYER FORMING LIQUID

(75) Inventors: Mutsuyuki KAWAGUCHI, Amagasaki-shi (JP); Satoshi SAITO, Amagasaki-shi (JP); Tsuyoshi AMATANI, Amagasaki-shi (JP); Yuko FUJII, Amagasaki-shi (JP); Yoichi SENGOKU, Amagasaki-shi (JP)

Correspondence Address: KNOBBE MARTENS OLSON & BEAR LLP, 2040 MAIN STREET, FOURTEENTH FLOOR, IRVINE, CA, 92614, US

(73) Assignee: MEC COMPANY LTD., Amagasaki-shi, (JP)

(21) Appl. No.: 12/495,247

(22) Filed: Jun. 30, 2009

(30) Foreign Application Priority Data
Jul. 2, 2008 (JP) 2008-173086

(51) Int. Cl. B44C 1/22; C09J 1/00; B05D 1/38

(52) U.S. Cl. 216/106; 106/287.19; 427/409

(57) ABSTRACT

An object of the present invention is to provide an adhesive layer forming liquid about which deterioration in adhesive-layer-forming capability with the passage of time can be restrained and further the smoothness of an adhesive layer surface can be certainly kept. The adhesive layer forming liquid of the present invention is an adhesive layer forming liquid, which is a liquid for forming an adhesive layer for bonding copper and a resin to each other, and which is an aqueous solution comprising an acid, a stannic salt, a complexing agent, a stabilizer, and a complexing restrainer for restraining a complexing reaction between the complexing agent and copper.

### BACKGROUND OF THE INVENTION

1. Field of the Invention

The present invention relates to an adhesive layer forming liquid for forming an adhesive layer for bonding copper and a resin to each other.

2. Description of the Related Art

Ordinary multilayer interconnection boards are each produced by laminating and pressing an internal substrate, which has, on its surface, an electroconductive layer made of copper, and one or more different internal substrates and/or one or more copper foil layers to sandwich one or more prepregs therebetween. The electroconductive layers are connected electrically to each other through open holes called through holes, the hole-walls of which are plated with copper. On the surface of the electroconductive layer of each of the internal substrates, a tin plating layer may be made from a tin plating solution described in Japanese Patent Application Publication (JP-B) No. 6-66553 and Japanese Patent Application Translated-Version National Publication No. 2004-536220 and others in order to improve the adhesive property of the layer surface onto the prepreg adjacent thereto.

However, about the tin plating solution described in Japanese Patent Application Publication (JP-B) No. 6-66553 and Japanese Patent Application Translated-Version National Publication No. 2004-536220, a stannous salt is used as a tin source; thus, a bivalent tin ion (Sn²⁺) is oxidized to a tetravalent tin ion (Sn⁴⁺) by air oxidation or the like when the solution is used. As a result, there is caused a problem that the plating adhesive property is lowered so that the closely adhesive property between tin and a resin is declined.

Against the problem, Japanese Patent Application Laid-Open (JP-A) No. 5-222540 and JP-A No. 5-263258 suggest a method of regenerating a bivalent tin ion from a tetravalent tin ion by use of metallic tin. However, according to this method, the adjustment of components in the tin plating solution is difficult. Thus, the method is poor in practicability.

In the meantime, JP-A No. 2004-349693 and JP-A No. 2005-23301 suggest a method of using a stannic salt as a tin source and further using an adhesive layer forming liquid to which a third metal ion other than copper and tin ions is added to stably form an adhesive layer.

However, when an adhesive layer forming liquid containing a stannic salt as a tin source is used, a complexing agent that is a component contained in the liquid causes the surface of the resultant adhesive layer to be roughened so that the smoothness of the adhesive layer surface may be damaged. In the method described in JP-A No. 2004-349693 and JP-A No. 2005-23301, the third metal ion, which is contained in the adhesive layer forming liquid, also has a function of roughening the adhesive layer surface in the same manner as the above-mentioned complexing agent. Thus, fine irregularities in a coral-like form are easily made in the adhesive layer surface. Accordingly, the method has a problem that the adhesive layer forming liquid cannot be applied to the formation of a wiring board into which a high-frequency current is caused to flow.

### SUMMARY OF THE INVENTION

In light of the above-mentioned actual situation, an object of the present invention is to provide an adhesive layer forming liquid about which deterioration in adhesive-layer-forming capability with the passage of time can be restrained and further the smoothness of an adhesive layer surface can be certainly kept.

The adhesive layer forming liquid of the present invention is an adhesive layer forming liquid, which is a liquid for forming an adhesive layer for bonding copper and a resin to each other, and which is an aqueous solution comprising an acid, a stannic salt, a complexing agent, a stabilizer, and a complexing restrainer for restraining a complexing reaction between the complexing agent and copper.

In the present invention, “copper” may be copper or any copper alloy. In the present specification, the word “copper” denotes copper or any copper alloy.

According to the adhesive layer forming liquid of the present invention, deterioration in adhesive-layer-forming capability of the liquid with the passage of time can be restrained, and further the smoothness of an adhesive layer surface can be secured.

### DETAILED DESCRIPTION OF THE PREFERRED EMBODIMENTS

The present invention is directed to an adhesive layer forming liquid for forming an adhesive layer made mainly of copper-tin alloy on a surface of copper in order to bond the copper and a resin to each other. The copper surface is, for example, a surface of a copper foil layer (such as an electrolytic copper foil layer or rolled copper foil layer) used for a semiconductor wafer, an electronic substrate, an electronic component such as a lead frame, an ornament, or a building member; a surface of a copper plating film (such as an electroless plating copper film or electroplating copper film); or a surface of a copper member which may be in various forms such as linear, rodlike, tubular, and tabular forms. Hereinafter, components contained in the adhesive layer forming liquid of the present invention will be described in detail.

### (Acid)

The acid contained in the adhesive layer forming liquid of the present invention functions as a pH adjustor and a tin ion stabilizer. Examples of the acid include inorganic acids, such as hydrochloric acid, sulfuric acid, nitric acid, fluoroboric acid, and phosphoric acid; and water-soluble organic acids, such as carboxylic acids such as formic acid, acetic acid, propionic acid and butyric acid, alkanesulfonic acids such as methanesulfonic acid and ethanesulfonic acid, and aromatic sulfonic acids such as benzenesulfonic acid, phenolsulfonic acid and cresolsulofnic acid. Of the acids, sulfuric acid and hydrochloric acid are preferred from the viewpoint of the rate of forming the adhesive layer, the solubility of the stannic salt therein, and the like. The concentration of the acid is preferably from 0.1 to 20.0% by weight, more preferably from 0.5 to 10.0% by weight, even more preferably from 1.0 to 5.0% by weight. When the concentration is in the range, an adhesive layer excellent in closely adhesive property can easily be formed.

### (Stannic Salt)

In the adhesive layer forming liquid of the present invention, a stannic salt is used as a tin source. Stannic salts have a higher stability in liquid than stannous salts; thus, according to the adhesive layer forming liquid of the invention, deterioration in adhesive-layer-forming capability thereof with the passage of time can be restrained. The stannic salt maybe selected from stannic salts soluble in an acidic solution without any especial limitation. From the viewpoint of solubility, a salt of tin with any one of the above-mentioned acids is preferred. Examples of the salt include stannic sulfate, stannic borofluoride, stannic fluoride, stannic nitrate, stannic chloride, stannic formate, and stannic acetate. The concentration of the stannic salt is a concentration giving preferably a tin concentration of 0.05 to 10.0% by weight, more preferably that of 0.1 to 5.0% by weight, even more preferably that of 0.5 to 3.0% by weight. When the concentration is in the range, an adhesive layer excellent in closely adhesive property can easily be formed.

### (Complexing Agent)

The complexing agent contained in the adhesive layer forming liquid of the present invention is an agent which is coordinated to the copper layer as an underlying layer to form a chelate, thereby making it easy to form the adhesive layer on the surface of the copper layer. For example, thioureas such as thiourea, 1,3-dimethylthiorea and 1,3-diethyl-2-thiourea; and thiourea derivatives such as thioglycolic acid may be used. The concentration of the complexing agent ranges preferably from 1.0 to 30.0% by weight, more preferably from 1.0 to 20.0% by weight. When the concentration is in this range, an adhesive layer excellent in closely adhesive property can easily be formed without lowering the rate of forming the adhesive layer. Moreover, the function of the complexing restrainer, which will be described in detail later, is effectively exhibited when the concentration is in this range. Thus, an adhesive layer good in smoothness can be formed.

### (Stabilizer)

The stabilizer contained in the adhesive layer forming liquid of the present invention is an additive for maintaining the concentrations of the individual components necessary for the reaction in the vicinity of the surface of the copper layer. Examples thereof include such as glycols such as ethylene glycol, diethylene glycol, propylene glycol and tripropylene glycol; and glycol esters such as cellosolve, carbitol and butyl carbitol. The concentration of the stabilizer ranges preferably from 1.0 to 80.0% by weight, more preferably from 5.0 to 80.0% by weight, and even more preferably from 10.0 to 80.0% by weight. When the concentration is in the range, the concentrations of the individual components necessary for the reaction can easily be maintained in the vicinity of the surface of the copper layer.

### (Complexing Restrainer)

The adhesive layer forming liquid of the present invention contains a complexing restrainer for restraining a complexing reaction between the complexing agent and copper. The complexing agent has a function of making the formation of an adhesive layer on a copper surface easy as described above while the agent is combined with copper contained in the surface of the adhesive layer to form a complex, thereby damaging the smoothness of the adhesive layer surface. Thus, in order to keep the smoothness of the adhesive layer surface certainly, the complexing restrainer is incorporated into the liquid. The reason why the incorporation of the complexing restrainer makes it possible to keep the smoothness of the adhesive layer surface certainly is unclear; however, the reason would be based on a matter that the complexing restrainer is combined with a part of the complexing agent and tin to form a complex, thereby restraining the complexing reaction between the complexing agent and copper from advancing excessively.

Examples of the complexing restrainer include phosphoric acids, phosphorous acids, and hypophosphorous acids. Examples of the phosphoric acids include phosphoric acid, sodium phosphate, potassium phosphate, sodium tripolyphosphate, potassium tripolyphosphate, sodium pyrophosphate, and potassium pyrophosphate. Examples of the phosphorous acids include phosphorous acid, sodium phosphite, potassium phosphite, calcium phosphite, magnesium phosphite, ammonium phosphite, and barium phosphite. Examples of the hypophosphorous acids include hypophosphorous acid, sodium hypophosphite, potassium hypophosphite, calcium hypophosphite, lithium hypophosphite, ammonium hypophosphite, nickel hypophosphite, and sodium hydrogenhypophosphite.

The concentration of the complexing restrainer is preferably from 0.1 to 30.0% by weight, more preferably from 1.0 to 20.0% by weight, even more preferably from 3.0 to 10.0% by weight. When the concentration is in the range, an adhesive layer high in smoothness and closely adhesive property can easily be formed.

In order to form an adhesive layer higher in smoothness and closely adhesive property easily in the present invention, the concentration of the complexing agent is preferably from 0.5 to 10.0 times that of the complexing restrainer, more preferably from 0.8 to 6.0 times that of the restrainer.

The adhesive layer forming liquid may contain, besides the above-mentioned components, additives such as a surfactant. Examples of the surfactant include such as nonionic surfactants, anionic surfactants, cationic surfactants, and ampholytic surfactants.

The adhesive layer forming liquid of the present invention can easily be prepared by dissolving the above-mentioned individual components into water. The water is preferably water from which ionic materials and impurities are removed, and preferred examples thereof include ion-exchange water, pure water, and ultra pure water.

In the case of using the adhesive layer forming liquid to form the adhesive layer, the formation can be attained under conditions described below.

First, the surface of the copper layer is washed with an acid or the like. Next, the copper layer is immersed into the adhesive layer forming liquid, and then subjected to swinging immersion treatment for 5 seconds to 5 minutes. At this time, it is advisable that the temperature of the adhesive layer forming liquid is from 20 to 70° C. (preferably 20 to 40° C.). Thereafter, the treated surface is rinsed with water and dried, thereby forming the adhesive layer.

Furthermore, the surface of the adhesive layer may be treated with a tin stripping solution. When the tin stripping solution is brought into contact with the adhesive layer surface, the layer can be rendered a smoother and thinner adhesive layer.

The above tin stripping solution may be any solution that is capable of etching tin. For example, an acidic solution or the like may be used, examples thereof including such as an aqueous nitric acid solution, hydrochloric acid, an aqueous sulfuric acid solution, and mixed solutions thereof. The concentration of the acid in the acidic solution ranges preferably from 0.1 to 10.0% by weight, more preferably from 0.3 to 5.0% by weight. When the concentration is in this range, the thickness of the adhesive layer can easily be controlled into an appropriate range. An aqueous nitric acid solution is particularly preferred since the solution gives a large stripping rate.

In the surface-stripping step, the period when the adhesive layer surface and the tin stripping solution (preferably, an aqueous nitric acid solution) contact each other is preferably from 5 to 120 seconds, more preferably from 10 to 30 seconds. When the period is in the range, the thickness of the adhesive layer can easily be controlled into an appropriate range. The method for bringing the tin stripping solution into contact with the surface may be immersion, or liquid-contacting treatment using a spray or the like. The temperature of the tin stripping solution in the method is from about 25 to 35° C.

The thickness of the adhesive layer is appropriately 0.02 μm or less, and is preferably from 0.001 to 0.02 μm, more preferably from 0.003 to 0.02 μm. When the thickness of the adhesive layer is set to 0.02 μm or less, the adhesive layer can easily be removed in a case where the adhesive layer is required to be removed in a subsequent step. On the other hand, when the thickness is set to 0.001 μm or more, the adhesive property to a resin layer can be certainly kept with ease.

The constituting resin of a resin layer to be bonded to the adhesive layer is not particularly limited. Examples of the resin include thermoplastic resins such as acrylonitrile/styrene copolymer resins (AS resins), acrylonitrile/butadiene/styrene terpolymer resins (ABS resins), fluorine-contained resins, polyamide, polyethylene, polyethylene terephthalate, polyvinylidene chloride, polyvinyl chloride, polycarbonate, polystyrene, polysulfone, polypropylene, and liquid crystal polymers; thermosetting resins such as epoxy resins, phenol resins, polyimide, polyurethane, bismaleimide/triazine resins, modified polyphenylene ether, and cyanate esters; and ultraviolet curable resins such as ultraviolet curable epoxy resins and ultraviolet curable acrylic resins These resins may be modified with a functional group, or may be reinforced with glass fiber, aramide fiber, some other fiber, or the like.

The adhesive layer obtained from the adhesive layer forming liquid of the present invention can ensure the adhesive property of the layer to an insulating resin, an etching resist, a solder resist, an electroconductive resin, an electroconductive paste, an electroconductive adhesive, a dielectric resin, a hole-filling resin, a flexible coverlay film, or the like. Thus, according to the present invention, adhesive property between a copper layer and a resin layer can be ensured. Accordingly, for example, a wiring board high in reliability can be supplied.

### EXAMPLES

Examples of the invention will be described together with comparative examples hereinafter. The invention should not be construed to be limited to the examples.

(Treatment with Fresh Liquids)

Adhesive layer forming liquids (temperature: 30° C.) having compositions in Table 1 described below, respectively, were each prepared by 1 liter. About each of the adhesive layer forming liquids, the balance other than the components shown in Table 1 was made of ion-exchange water. Electroplating copper foil pieces (trade name: 3EC-III, manufactured by Mitsui Mining Co., Ltd.; thickness: 35 μm) each cut into a size of 100 mm×100 mm were prepared as test pieces. Any one of the test pieces was put into each of the liquids (fresh liquids), and then the piece was subjected to swinging immersion treatment for 30 seconds. Thereafter, the treated test piece was washed with water, and immediately the piece was subjected to swinging immersion treatment with a 0.7% by weight of an aqueous nitric acid solution (temperature: 30° C.) for 20 seconds. Thereafter, the piece was washed with water, and dried.

(Treatment with Used Liquids)

Separately from the above, adhesive layer forming liquids (temperature: 30° C.) having the compositions in Table 1 described below, respectively, were each prepared by 1 liter. While each of the adhesive layer forming liquids was stirred, 500 pieces of the same test pieces as described above were continuously treated therewith under the same conditions as described above over 24 hours. Next, any one of the same test pieces as described above was put into each of the liquids (used liquids) used for the treatment, and then treated under the same conditions as described above. Thereafter, the treated test pieces were each washed with water, and immediately the piece was subjected to swinging immersion treatment with a 0.7% by weight of an aqueous nitric acid solution (temperature: 30° C.) for 20 seconds. Thereafter, the piece was washed with water, and dried.

### (Adhesion Evaluation)

A photosensitive liquid solder resist (trade name: SR-7200, manufactured by Hitachi Chemical Co., Ltd.) was applied into a thickness of about 20 μm over each of the treated test pieces so as to interpose the adhesive layer therebetween, and then cured. Thereafter, in accordance with JIS C 6471, the peel strength (N/mm) was measured. The results are shown in Table 1.

### (Smoothness Evaluation)

The surface of each of the treated test pieces was observed with a scanning electron microscope (magnification power: 3500), and the smoothness was evaluated. Of the test pieces, any piece wherein the average number of pitting corrosions per area of 100 μm² was 0, from 1 to 4, from 5 to 9, or 10 or more was judged to be very good (⊙), good (◯), allowable (Δ), or unallowable (×), respectively. The average number of pitting corrosions was the average number of values obtained by observing any five spots in each of the test pieces. The results are shown in Table 1.

TABLE 1

| | | | | | | | | Peel | | |
|---|---|---|---|---|---|---|---|---|---|---|
| | Liquid components (any parenthesized numerical value represents the | | | | | | Complexing | strength | | |
| | concentration (% by weight) of the corresponding component) | | | | | | agent/ | (N/mm) | | |
| | | | | | Complexing | Other | complexing | Fresh | Used | Smooth- |
| | Acid | Tin source | Complexing agent | Stabilizer | restrainer | component | restrainer | liquid | liquid | ness |
| Example 1 | Hydrochloric | Stannic | Thiourea | Diethylene | Sodium | — | 0.3 | 0.82 | 0.80 | ⊙ |
| | acid | chloride | (11.0) | glycol | hypophosphite | | | | | |
| | (2.1)*1 | (1.7)*2 | | (40.0) | (35.0) | | | | | |
| Example 2 | Hydrochloric | Stannic | Thiourea | Diethylene | Sodium | — | 0.5 | 0.93 | 0.90 | ⊙ |
| | acid | chloride | (15.0) | glycol | hypophosphite | | | | | |
| | (2.1)*1 | (1.7)*2 | | (40.0) | (30.0) | | | | | |
| Example 3 | Hydrochloric | Stannic | Thiourea | Diethylene | Sodium | — | 1.0 | 0.95 | 0.96 | ⊙ |
| | acid | chloride | (10.0) | glycol | hypophosphite | | | | | |
| | (2.1)*1 | (1.7)*2 | | (40.0) | (10.0) | | | | | |
| Example 4 | Hydrochloric | Stannic | Thiourea | Diethylene | Sodium | — | 1.8 | 1.12 | 1.10 | ⊙ |
| | acid | chloride | (11.0) | glycol | hypophosphite | | | | | |
| | (2.1)*1 | (1.7)*2 | | (40.0) | (6.0) | | | | | |
| Example 5 | Hydrochloric | Stannic | Thiourea | Diethylene | Sodium | — | 5.0 | 1.13 | 1.08 | ⊙ |
| | acid | chloride | (15.0) | glycol | hypophosphite | | | | | |
| | (2.1)*1 | (1.7)*2 | | (40.0) | (3.0) | | | | | |
| Example 6 | Hydrochloric | Stannic | Thiourea | Diethylene | Sodium | — | 10.0 | 1.09 | 1.02 | ◯ |
| | acid | chloride | (1.0) | glycol | hypophosphite | | | | | |
| | (2.1)*1 | (1.7)*2 | | (40.0) | (0.1) | | | | | |
| Example 7 | Hydrochloric | Stannic | Thiourea | Diethylene | Sodium | — | 13.8 | 1.02 | 0.99 | Δ |
| | acid | chloride | (11.0) | glycol | hypophosphite | | | | | |
| | (2.1)*1 | (1.7)*2 | | (40.0) | (0.8) | | | | | |
| Example 8 | Hydrochloric | Stannic | Thiourea | Diethylene | Hypophosphorous | — | 1.8 | 1.10 | 1.13 | ⊙ |
| | acid | chloride | (11.0) | glycol | acid | | | | | |
| | (2.1)*1 | (1.7)*2 | | (40.0) | (6.0) | | | | | |
| Example 9 | Sulfuric acid | Stannic | Thiourea | Diethylene | Sodium | — | 1.8 | 1.05 | 1.04 | ⊙ |
| | (2.1) | chloride | (11.0) | glycol | hypophosphite | | | | | |
| | | (1.7)*2 | | (40.0) | (6.0) | | | | | |
| Example | Hydrochloric | Stannic | 1,3-Dimethylthio | Diethylene | Sodium | — | 1.8 | 1.07 | 1.07 | ⊙ |
| 10 | acid | chloride | urea | glycol | hypophosphite | | | | | |
| | (2.1)*1 | (1.7)*2 | (40.0) | (6.0) | | | | | | |
| | | | (11.0) | | | | | | | |
| Example | Hydrochloric | Stannic | Thiourea | Tripropylene | Sodium | — | 1.8 | 1.11 | 1.08 | ⊙ |
| 11 | acid | chloride | (11.0) | glycol | hypophosphite | | | | | |
| | (2.1)*1 | (1.7)*2 | | (40.0) | (6.0) | | | | | |
| Comparative | Sulfuric acid | Stannous | Thiourea | Diethylene | — | — | — | 1.02 | 0.40 | ◯ |
| Example 1 | (13.9) | sulfate | (4.4) | glycol | | | | | | |
| | | (1.0)*2 | | (40.0) | | | | | | |
| Comparative | Sulfuric acid | Stannous | Thiourea | Diethylene | Sodium | — | 1.5 | 0.91 | 0.48 | ◯ |
| Example 2 | (13.9) | sulfate | (4.4) | glycol | hypophosphite | | | | | |
| | | (1.0)*2 | | (40.0) | (3.0) | | | | | |
| Comparative | Hydrochloric | Stannic | Thiourea | Diethylene | — | Nickel | — | 1.10 | 1.06 | X |
| Example 3 | acid | chloride | (12.0) | glycol | | sulfate | | | | |
| | (1.1)*1 | (1.5)*2 | | (40.0) | | (1.1)*3 | | | | |
| Comparative | Hydrochloric | Stannic | Thiourea | Diethylene | — | — | — | 1.10 | 1.11 | X |
| Example 4 | acid | chloride | (11.0) | glycol | | | | | | |
| | (2.1)*1 | (1.7)*2 | | (40.0) | | | | | | |

*1Hydrogen chloride concentration
*2Tin concentration
*3Nickel concentration

As shown in Table 1, in Examples 1 to 11 of the present invention, good results were obtained in both of the peel strength and the smoothness.

On the other hand, in Comparative Examples 1 and 2, wherein a stannous salt was used as a tin source, the peel strength was lowered in the case of the used liquid treatment. In Comparative Examples 3 and 4, wherein no complexing restrainer was contained although a stannic salt was used as a tin source, the smoothness was deteriorated. It has been understood from the results of Comparative Examples 1 and 2 that when a stannous salt is used, the advantageous effect of a complexing restrainer is hardly produced.

1. An adhesive layer forming liquid, which is a liquid for forming an adhesive layer for bonding copper and a resin to each other, and
which is an aqueous solution comprising an acid, a stannic salt, a complexing agent, a stabilizer, and a complexing restrainer for restraining a complexing reaction between the complexing agent and copper.

2. The adhesive layer forming liquid according to claim 1, wherein the complexing restrainer is at least one selected from the group consisting of phosphoric acids, phosphorous acids, and hypophosphorous acids.

3. The adhesive layer forming liquid according to claim 1, wherein the complexing restrainer is contained in an amount of 0.1 to 30.0% by weight.

4. The adhesive layer forming liquid according to claim 1, wherein the complexing agent is at least one selected from the group consisting of thioureas, and thiourea derivatives.

5. The adhesive layer forming liquid according to claim 1, wherein the stabilizer is at least one selected from the group consisting of glycols and glycol esters.

6. The adhesive layer forming liquid according to claim 1, wherein the concentration of the complexing agent is from 0.5 to 10.0 times that of the complexing restrainer.

7. A method for bonding copper and a resin to each other comprising:
preparing an adhesive layer forming liquid according to claim 1;
immersing the copper into the adhesive layer forming liquid;
washing the copper with water; and
applying the resin to the copper.

8. The method for bonding copper and a resin to each other according to claim 7, wherein the temperature of the adhesive layer forming liquid is from 20° C. to 70° C.

9. The method for bonding copper and a resin to each other according to claim 7, further comprising immersing the copper into a tin stripping solution.

10. The method for bonding copper and a resin to each other according to claim 9, wherein the tin stripping solution is solution capable of etching tin, including an aqueous nitric acid solution, hydrochloric acid, an aqueous sulfuric acid solution, and mixed solution thereof.
